(19) United States
(12) Patent Application Publication
(10) Pub. No.: US 2018/0309184 A1
(43) Pub. Date: Oct. 25, 2018

(54) ANTENNA MOUNTING COMPONENT AND ANTENNA DEVICE

(71) Applicant: Kenichi IWAKAMI, Katagami-shi (JP)

(72) Inventor: Kenichi IWAKAMI, Katagami-shi (JP)

(73) Assignee: MITSUMI ELECTRIC CO., LTD., Tokyo (JP)

(21) Appl. No.: 15/957,603

(22) Filed: Apr. 19, 2018

(30) Foreign Application Priority Data
Apr. 24, 2017 (JP) 2017-085158

(51) Int. Cl. H01Q 1/12; H01Q 1/32

(52) U.S. Cl. CPC H01Q 1/1207; H01Q 1/3275

(57) ABSTRACT

An antenna mounting component to be mounted to an aperture for fixing on a mounting surface of a car body includes: a male screw for fixing an antenna; a female screw which is provided on an antenna base and corresponds to the male screw; and a fixing member which is fixed onto the mounting surface when the fixing member is pinched by the male screw and the female screw, the male screw being inserted in the fixing member. When the fixing member axially rotates about the inserted male screw, the state of the fixing member is converted from a first state into a second state, the first state being a state in which the fixing member is insertable through the aperture for fixing and the second state being a state in which the fixing member is not insertable through the aperture for fixing.

### CROSS-REFERENCE TO RELATED APPLICATIONS

This application is based upon and claims the benefit of priority from the prior Japanese Patent Application No. 2017-085158, filed on Apr. 24, 2017, the entire contents of which, including the specification, claims, drawings and abstract, are incorporated herein by reference.

### BACKGROUND OF THE INVENTION

### 1. Field of the Invention

The present invention relates to an antenna mounting component and an antenna device.

### 2. Description of Related Art

On-vehicle antennas, such as rod antennas, are known that are mounted onto car bodies to receive radio waves of, for example, AM/FM radio broadcast An antenna-mounting structure onto a car body is known that includes a male screw (bolt) to be inserted into an aperture for fixing formed in an antenna base of the antenna and provided on the roof of the car body, and a female screw (nut) for tightening the male screw from the inside of the car (see Japanese Patent Nos. 3956473 and 4780640).

However, the antenna-mounting structures in Japanese Patent Nos. 3956473 and No. 4780640 provides the male screw and the female screw (and a washer) as separate components, leading to troublesome mounting work and many processes for assembly. Another antenna-mounting structure is known that includes a female screw hole formed on an antenna base, a male screw, a stiffening plate, and a legged washer having a square shape with rectangular legs provided along the entire lengths of the three of the four sides and radially unfolding around the axis through tightening of a male screw into the female screw hole, in order to readily mount the antenna to the car body (see Japanese Patent No. 5112465). The male screw, the stiffening plate, and the legged washer are temporarily fastened through the female screw hole (the antenna base) integrally with the three legs folded. The integral antenna-mounting structure is inserted into the aperture for fixing on the roof of the car body, to cause the male screw to be tightened. The legs of the legged washer then unfold in three directions, such that the antenna is mounted onto the car body.

However, the antenna-mounting structure described in Japanese Patent No. 5112465 requires a prescribed length of stroke in the rotation axis direction of the male screw so that the legs of the legged washer unfold by tightening the male screw into the female screw hole. The stroke in turn causes a problem of an increasing protrusion amount of the antenna into the car from the roof of the car body.

The object of the present invention is to reduce the protrusion amount of the antenna into the car from the roof of the car body.

### SUMMARY OF THE INVENTION

To achieve at least one of the above mentioned objects, according to an aspect of the present invention, there is provided an antenna mounting component to be mounted to an aperture for fixing on a mounting surface of a car body, including: a male screw for fixing an antenna; a female screw which is provided on an antenna base and corresponds to the male screw; and a fixing member which is fixed onto the mounting surface when the fixing member is pinched by the male screw and the female screw, the male screw being inserted in the fixing member, wherein, when the fixing member axially rotates about the inserted male screw, a state of the fixing member is converted from a first state into a second state, the first state being a state in which the fixing member is insertable through the aperture for fixing and the second state being a state in which the fixing member is not insertable through the aperture for fixing.

Preferably, the antenna mounting component further includes a guide, wherein, when the fixing member is pinched by the male screw and the female screw, the guide contacts at least one guided portion of the fixing member so that a state of the fixing member is converted from the first state into the second state.

Preferably, in the antenna mounting component, the fixing member includes a guided member and a fixing nut, the guided member including the at least one guided portion and the fixing nut being separate from the guided member, the guided member has a hole in which the male screw is inserted, the at least one guided portion includes a plurality of guided portions disposed at equal intervals in the circumferential direction around the hole, and the fixing nut has at least one aperture in which the guided portions are inserted.

Preferably, in the antenna mounting component, the fixing nut includes at least one projection which pushes at least one of the guided portions inserted in the at least one aperture.

Preferably, in the antenna mounting component, the fixing nut has slits radially formed around the inserted male screw.

To achieve at least one of the above mentioned objects, according to another aspect of the present invention, there is provided an antenna device including: an antenna mounting component according to the present invention; and an antenna.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a perspective view of an antenna device according to an embodiment of the present invention;

FIG. 2 is a plan view of a mounting surface having an aperture for fixing;

FIG. 3 is an exploded view of the lower portion of the antenna device;

FIG. 4 is a bottom view of an antenna base in a state in which a hook is incorporated;

FIG. 5 illustrates an antenna mounting portion in the initial mounting state:

FIG. 6 illustrates an antenna mounting portion in the semi-mounting state;

FIG. 7 illustrates the antenna mounting portion in the mounted state;

FIG. 8 illustrates an exploded view of the lower portion of the antenna device according to a modification;

FIG. 9 illustrates a bottom view of an antenna base in a state in which a hook of the antenna device is incorporated according to the modification;

FIG. 10 illustrates an antenna mounting portion in the initial mounting state of the antenna device according to the modification; and

FIG. 11 illustrates the antenna mounting portion in the mounted state of the antenna device according to the modification.

### DETAILED DESCRIPTION OF THE PREFERRED EMBODIMENT

The embodiments and their modifications of the present invention will now be described in detail in reference to the drawings. The scope of the present invention, however, should not be limited to the illustrated embodiments and modifications.

### Embodiments

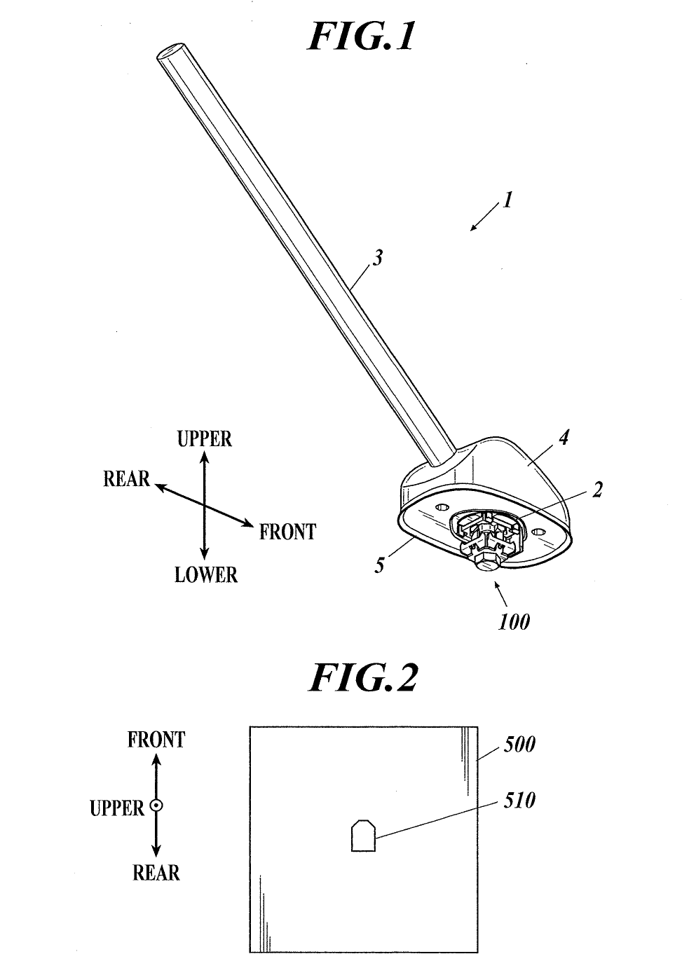

The embodiments of the present invention will now be described in reference to FIGS. 1 to 7. The overall configuration of a device according to the present embodiment will be described in reference to FIGS. 1 to 4. FIG. 1 is a perspective view of an antenna device 1 according to the present embodiment. FIG. 2 is a plan view of amounting surface 500 having an aperture for fixing 510.

The antenna device 1 according to the present embodiment is an on-vehicle antenna mounted on the roof (mounting surface) of a car body. The antenna device 1 may be used for reception of AM/FM broadcast, for example, but not limited thereto, and may also be used for any other communication schemes, such as GSM (registered trademark) (Global System for Mobile communications).

The antenna device 1 includes an antenna base 2, an antenna 3, an antenna cover 4, and a gasket 5, as illustrated in FIG. 1. The antenna device 1 also has an antenna mounting portion 100 as an antenna mounting component, which includes a part of the antenna base 2 and mounts an antenna to the car body.

The antenna base 2 is the base of the antenna device 1, and is made of a die cast metal, such as aluminum. The antenna base 2 has a top face on which an antenna substrate (not shown) is fixed. A tuning circuit and an amplifier circuit are disposed for selectively receiving only specific frequencies of radio waves. The antenna substrate is electrically connected with various types of cables, such as RF cables, electric wires, and grounding (GND) wires, for connection with communication devices provided within the car body.

The antenna 3 is a bar-shaped rod antenna. The antenna 3 includes, for example, a rod support, a conductor wire as an antenna element spirally wound on a bar-shaped support, and an insulating material covering the antenna element. The antenna element is electrically connected with the antenna substrate.

The antenna cover 4 covers the antenna base 2, the antenna substrate on the antenna base 2, and the like, and supports the antenna 3. In other words, the antenna 3 is fixed to the antenna base 2 through the antenna cover 4.

The gasket 5 is mounted to the lower surface of the antenna base 2. The gasket 5 is held between the antenna base 2 and a mounting surface 500, which will be discussed below, of the car body after the antenna device 1 is mounted on the car body, and has a function to keep water tightness in the antenna cover 4 and the inside of the car.

The mounting surface 500 or roof of the car body has the aperture for fixing 510 thereon, as illustrated in FIG. 2. The antenna device 1 is mounted into the aperture for fixing 510 on the mounting surface 500 through the antenna mounting portion 100. For a reduction in weight of the car body, the thickness of the mounting surface 500 is determined to be 0.6 mm or 0.5 mm, for example. The aperture for fixing 510 is a through hole which has a hexagonal shape in combination of an isosceles trapezoid and a rectangle.

As illustrated in FIGS. 1 and 2, defined are the upper (to the outside of the car) and lower (to the inside of the car) directions perpendicular to the bottom surface of the antenna base 2 of the antenna device 1 or the plane on the mounting surface 500 in the position of the aperture for fixing 510, after the antenna device 1 is mounted to the mounting surface 500. Also defined are front and rear directions perpendicular to the upper and lower directions and relative to the antenna device 1 or the mounting surface 500 (car body).

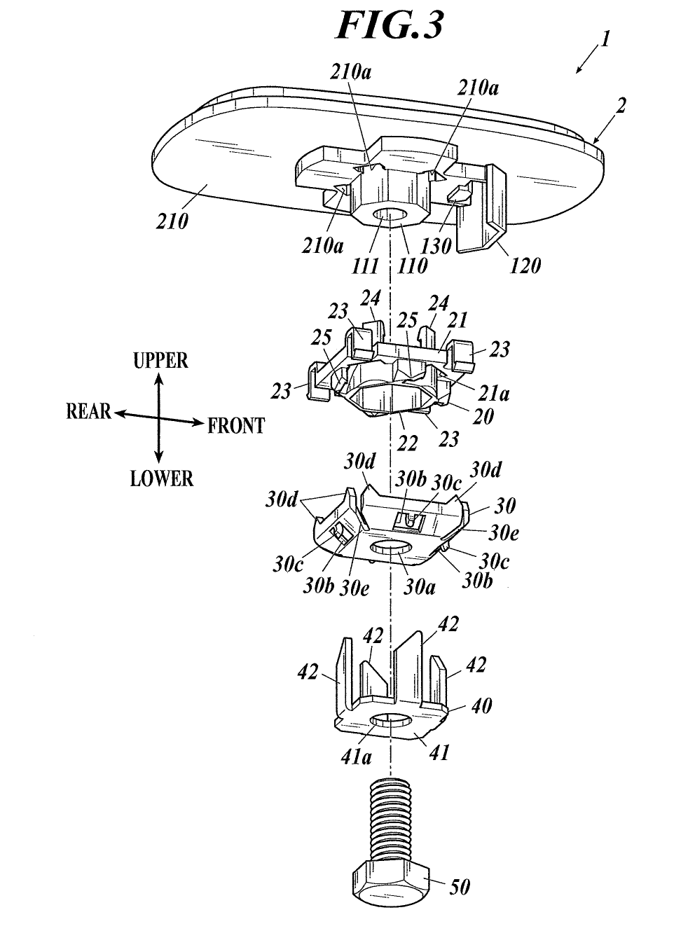

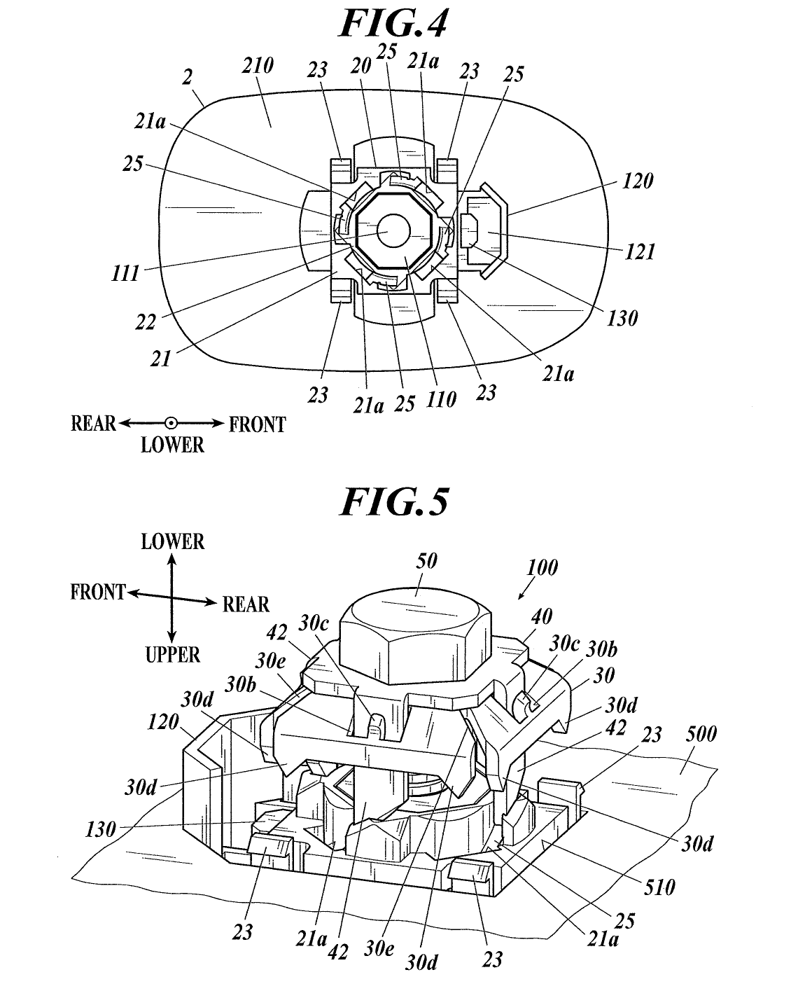

The configuration of the antenna mounting portion 100 will now be described in reference to FIGS. 3 and 4. FIG. 3 is an exploded view of the lower portion of the antenna device 1. FIG. 4 is a bottom view of the antenna base 2 in a state in which a hook 20 is incorporated. For clarity, the gasket 5 is not depicted in FIG. 3.

The antenna base 2 includes a plane 210 as a main part of the base, a protrusion 110 as apart of the antenna mounting portion 100, a cable guide 120, and a height adjusting portion 130, as illustrated in FIG. 3. The antenna mounting portion 100 includes the hook 20, a fixing nut 30 as a fixing member, a guide plate 40, and a male screw 50 for fixing the antenna.

The plane 210 is integrated with the protrusion 110, the cable guide 120, and the height adjusting portion 130 as a die cast.

The protrusion 110 has a substantially octagonal shape downwardly extending from the plane 210 and having eight sidewalls, and has a female screw 111 disposed at the center of the lower surface and in the vertical axial direction.

The plane 210 has through holes 210a respectively formed at the outside of the base of every other four sidewalls out of the eight sidewalls of the protrusion 110 described above. In the through holes 210a are respectively inserted four fixing claws 24 of the hooks 20, which will be discussed below. The fixing claws 24 inserted in each of the through holes 210a is engaged with a portion on the upper side of the plane 210.

The cable guide 120 is provided anterior to the protrusion 110 on the plane 210, and downwardly protrudes. A cable hole 121 is formed between the protrusion 110 and the cable guide 120 in the plane 210, as illustrated in FIG. 4. Various types of cables are connected with the antenna substrate provided on the antenna base 2 and extend through the cable hole 121 toward the interior of the car body. The cable guide 120 guides the various types of cables extending through the cable hole 121 toward the interior of the car body.

The height adjusting portion 130 is arranged at the position of the claws 30d. of the fixing nut 30 discussed below, which do not contact the mounting surface 500 when the antenna device 1 is mounted to the mounting surface 500. The height adjusting portion 130 is a bottom-up part to adjust the height of the plane 210 and the height of the surface of the mounting surface 500 from the upper direction to the lower direction. That is, the height adjusting portion 130 projects from the aperture for fixing 510 to approximately the same height as the mounting surface 500.

The hook 20 temporarily fixes (temporarily adheres) the antenna device 1 to the aperture for fixing 510 when the antenna device 1 is mounted to the mounting surface 500. The hook 20 has a hook base 21 having a substantially square shape in a plan view, a tubular member 22, temporary fixing claws 23, fixing claws 24, and guides 25. The hook base 21 is integrated with the tubular member 22, the temporary fixing claws 23, the fixing claws 24, and the guides 25 as a die cast.

The tubular member 22 has a substantially cylindrical shape in which the protrusion 110 described above is inserted.

The hook base 21 has four through holes 21a and four guides 25 respectively at equal intervals in the circumferential direction outside of the base of the above tubular member 22. The guides 25 are positioned alternately with the four through holes 21a, as shown in FIG. 4, and guide the legs 42 of the guide plate 40, which will be discussed below, to the through holes 21a. For example, each of the four through holes 21a is at the position turned by 45 degree around the female screw 111 from the position of each of the guides 25. Each of the through holes 21a is positioned so as to communicate with each of the through holes 210a formed on the plane 210 described above when the hook 20 is incorporated in the antenna base 2.

The temporary fixing claws 23 temporarily fix (temporarily adhere) the antenna device 1 to the aperture for fixing 510 when the antenna device 1 is mounted to the mounting surface 500. The temporary fixing claws 23 are hook-shaped and extensively provided at both ends of the left sidewall and the right sidewall of the hook base 21, respectively.

The fixing claws 24 fix the hook 20 to the plane 210 of the antenna base 2. The fixing claws 24 project above the sidewall of the tubular member 22, where the through holes 21a are drilled at the outside of the base of the cylindrical member 22 described above.

The guides 25 guide legs 42 of the guide plate 40, which will be discussed below, to the through holes 21a when the antenna device 1 is mounted to the mounting surface 500. The guides 25 are slopes along an ark and inclined downward in the clockwise direction (in the direction of tightening the male screw 50).

The fixing nut 30 is, for example, made of iron and fixes the antenna device 1 temporarily fixed to the aperture for fixing 510 by the hook 20 described above. The fixing nut 30 has a hollow truncated quadrangular pyramid shape having an aperture on a bottom surface (the bottom surface of upper side in FIG. 3). The fixing nut 30 has a hole 30a in which the male screw 50 is inserted at the center of a bottom surface (the bottom surface of lower side in FIG. 3). On each side surface of the fixing nut 30 is respectively formed an aperture 30b in which each of the legs 42 of the guide plate 40, which will be discussed below, is inserted. Each of the apertures 30b is a through hole having a substantially rectangular shape and has a projection 30c which projects downward (from the bottom surface of upper side to the bottom surface of lower side in FIG. 3) from the edge of the aperture 30b. The projection 30c holds the leg 42 inserted in the aperture 30b. The fixing nut 30 has claws 30d respectively formed at both ends of each side of the opened bottom surface (bottom surface of upper side in FIG. 3). The claws 30d respectively stick into the surface of the mounting surface 500 or come into contact with the surface of the height adjusting portion 130. The fixing nut 30 has slits 30e between adjacent side surfaces. The slits 30e improve processability of the fixing nut 30 and prevent deformation of one side surface from affecting the other side surfaces.

The guide plate (guided member) 40 is, for example, made of iron and has a plane 41 and four legs (guided portions) 42. The plane 41 has a substantially square shape in a plan view and has a hole 41a at the center in which the male screw 50 is inserted. The legs 42 are provided extensively and upwardly respectively from the center of each side of the plane 41. The tip of each leg 42 is inclined at a prescribed angle corresponding to the every slope of the guides 25 described above.

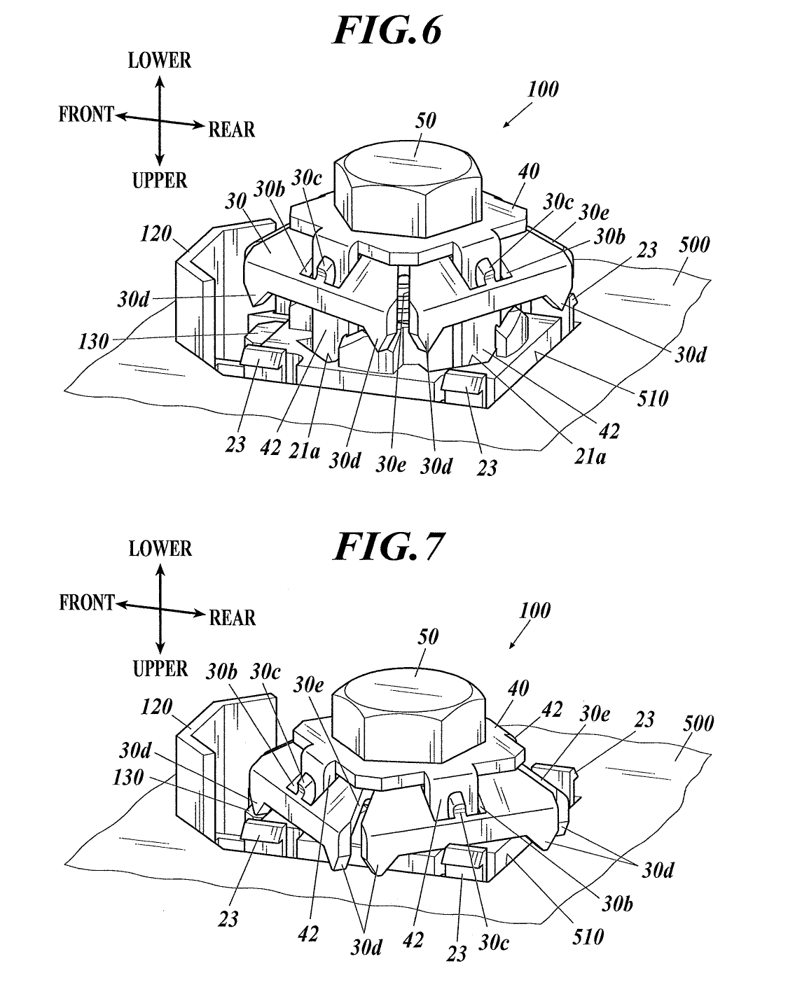

How the antenna device 1 is mounted to the mounting surface 500 of the car body by a worker will now be described in reference to FIGS. 5 to 7. FIG. 5 illustrates an antenna mounting portion 100 in the initial mounting state. FIG. 6 illustrates the antenna mounting portion 100 in the semi-mounting state. FIG. 7 illustrates the antenna mounting portion 100 in the mounted state.

As illustrated in FIG. 1, the antenna device 1 has been integrally assembled at the time when the antenna device 1 is mounted to the mounting surface 500. The male screw 50 has been tightened into the female screw 111 through the hook 20, the fixing nut 30, and the guide plate 40, in the antenna mounting portion 100 in the initial mounting state. The degree of tightening, however, is small.

With reference to FIG. 5, the worker inserts and temporarily fixes the antenna mounting portion 100 of the antenna device 1 in the initial state (the first state) into the aperture for fixing 510 on the mounting surface 500 from the upper part (from the outside of the car) to the lower part (to the inside of the car). Four of the temporary fixing claws 23 are engaged with the inside of the aperture for fixing 510, in the initial state in which the antenna mounting portion 100 is temporarily fixed. The antenna mounting portion 100, therefore, cannot be detached from the aperture for fixing 510, even if the worker exerts force from the lower direction (from the inside of the car) on the antenna mounting portion 100 for fastening.

The four legs 42 are in contact with every slope of the guides 25, respectively, in the temporarily fixed antenna mounting portion 100 in the initial state.

The worker then tightens the male screw 50, which exerts an upward axial force onto the fixing nut 30 and the guide plate 40. With reference to FIG. 6, as the male screw 50 is tightened, the tips of the legs 42 are respectively guided by the guides 25 to slide on the slopes and to move toward the through holes 21a, and the fixing nut 30 and the guide plate 40 rotate in the clockwise direction.

The worker then completely tightens the male screw 50, which exerts an upward axial force onto the fixing nut 30 and the guide plate 40. With reference to FIG. 7, as the male screw is tightened, the fixing nut 30 and the guide plate 40 further rotate in the clockwise direction until the tips of the legs 42 are inserted into the through holes 21a and fixed at the position turned by 45 degree (the second state) from the position in the initial state (the first state) described above. Finally, six claws 30d out of the eight claws 30d stick into the mounting surface 500 and the remaining two claws 30d come into contact with the height adjusting portion 130. The six claws 30d stick into the mounting surface 500 through coating and come into contact with a conductor portion. This causes the antenna base 2 to be grounded by electrical connection with the car body through the antenna mounting portion 100.

According to the present embodiment, the antenna mounting portion 100 includes the male screw 50, the female screw 111 provided on the antenna base 2 and corresponding to the male screw 50, and the fixing member (the fixing nut 30 and the guide plate 40) fixed onto the mounting surface 500 when the fixing member is pinched by the male screw 50 and the female screw 111, the male screw 50 being inserted in the fixing member. When the fixing member axially rotates about the inserted male screw 50, the state of the fixing member is converted from the first state into the second state. The fixing member in the first state is insertable through the aperture for fixing 510 and the fixing member in the second state is not insertable through the aperture for fixing 510.

Accordingly, when the male screw 50 is tightened in the female screw 111, it is not required to ensure the prescribed length of stroke (stroke in the rotation axis direction of the male screw) for unfolding the moving parts (legs) of the legged washer as in the conventional antenna-mounting structure. As a result, the protrusion amount of the antenna mounting portion 100 into the car from the mounting surface 500 can be reduced so that the space in the car can be prevented from being narrowed.

According to the present embodiment, the antenna mounting portion 100 has the guides 25 which come into contact with the guided portions (legs 42) of the fixing member when the male screw 50 and the female screw 111 pinch the fixing member (the fixing nut 30 and the guide plate 40), so that the fixing member in the first state, in which the fixing member is insertable through the aperture for fixing 510, changes into the fixing member in the second state, in which the fixing member is not insertable through the aperture for fixing 510. In conjunction with the tightening of the male screw 50, the fixing member (the fixing nut 30 and the guide plate 40) in the first state can be smoothly changed to the fixing member in the second state. Accordingly, the antenna mounting portion 100 can be mounted to the mounting surface 500 with higher work efficiency.

According to the present embodiment, the fixing member (the fixing nut 30 and the guide plate 40) has the guide plate 40 having legs 42 and the fixing nut 30 formed separately from the guide plate 40. The guide plate 40 has a hole 41a in which the male screw 50 is inserted. The legs 42 are disposed at equal intervals in the circumferential direction around the hole 41a as a center. The fixing nut 30 has apertures 30b in which legs 42 are inserted. Because the fixing nut 30 and the guide plate 40 are assembled by insertion of the legs 42 of the guide plate 40 in the apertures 30b of the fixing nut 30, the formed fixing member has improved strength and improved precision.

According to the present embodiment, the fixing nut 30 has the projections 30c which hold the legs 42 inserted in the apertures 30b. Accordingly, the legs 42 inserted in the aperture 30b do not easily fall out.

According to the present embodiment, the fixing nut 30 has the slits 30e radially formed around the inserted male screw 50 as a center. The slits 30e improve processability of the fixing nut 30 and prevent deformation of one side surface from affecting the other side surfaces.

### Modifications

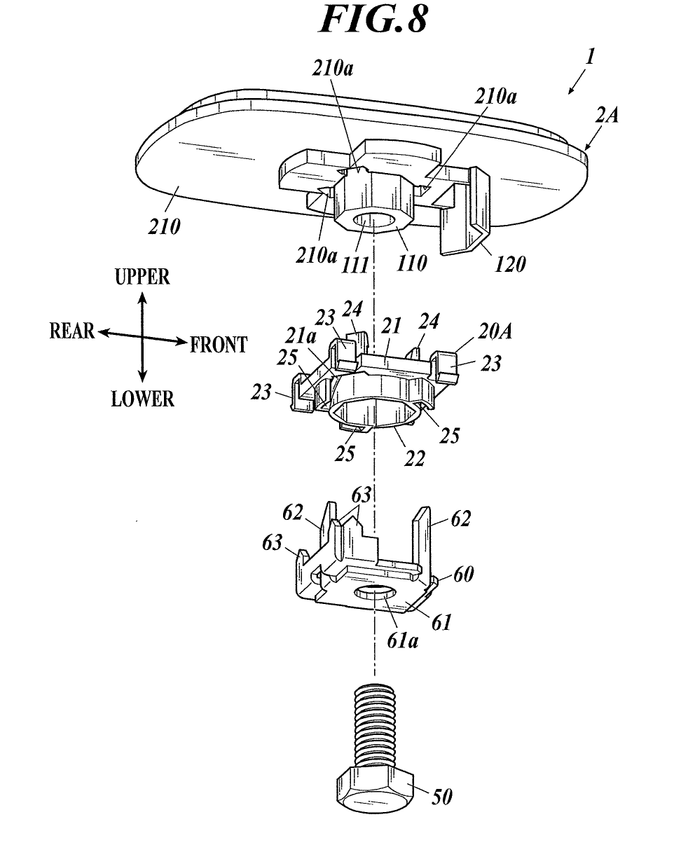

The modifications of the embodiments described above will now be described in reference to FIGS. 8 to 11. The same reference numeral is applied to the component which has the same configuration and the description is omitted.

The present modification provides a configuration of the antenna device 1 that includes an antenna mounting portion 100A instead of the antenna mounting portion 100 in the above-described embodiments, where the antenna mounting portion 100A is mounted onto the mounting surface 500.

First, the configuration of the antenna mounting portion 100A will be described in reference to FIGS. 8 and 9. FIG. 8 is an exploded view of the lower portion of the antenna device 1. FIG. 9 is a bottom view of the antenna base 2A in a state in which a hook 20A is incorporated. For clarity, the gasket 5 is not depicted in FIG. 8.

The antenna base 2A includes a plane 210 as a main part of the base, a protrusion 110 as a part of the antenna mounting portion 100A, and a cable guide 120, as illustrated in FIG. 8. The antenna mounting portion 100A includes the hook 20A, a fixing member 60, and the male screw 50 for fixing the antenna.

The plane 210 is integrated with the protrusion 110 and the cable guide 120 as a die cast.

The plane 210 has through holes 210a respectively formed at the outside of the base of predetermined three sidewalls out of the eight sidewalls of the protrusion 110 described above. In the three through holes 210a are respectively inserted three fixing claws 24 of the hooks 20A, which will be discussed below. Each of the fixing claws 24 inserted in each of the holes 210a is engaged with a portion on the upper side of the plane 210.

The hook 20A temporarily fixes (temporarily adheres) the antenna device 1 to the aperture for fixing 510 when the antenna device 1 is mounted to the mounting surface 500. The hook 20A has a hook base 21 having a substantially square shape in a plan view, a tubular member 22, temporary fixing claws 23, fixing claws 24, and guides 25.

As illustrated in FIG. 9, The hook base 21 has through holes 21a at three predetermined positions outside of the base of the sidewalls of the tubular member 22 described above. The guides 25 provided adjacent to the through holes 21a guide legs 62 of the fixing member 60, which will be discussed below, to the through holes 21a.

The guides 25 guide legs 62 of the fixing member 60, which will be discussed below, to the through holes 21a when the antenna device 1 is mounted to the mounting surface 500. The guides 25 are slopes along an ark and inclined downward in the clockwise direction (in the direction of tightening the male screw 50).

The fixing member 60 fixes the antenna device 1 temporarily fixed to the aperture for fixing 510 by the hook 20A described above.

The fixing member 60 has a plane 61, three legs 62, and six claws 63. The plane 61 has a substantially square shape in a plan view and has a hole 61a at the center for the male screw 50. The legs 62 are provided extensively and upwardly from the center of each of predetermined two adjacent sides of the plane 61 and from the corner where two sides other than the predetermined two adjacent sides intersect with each other. Two claws 63 are provided upwardly from each of the three corners of the plane 61, which are not the above-described corner from which the leg 62 is extensively provided. The claws 63 stick into the surface of the mounting surface 500.

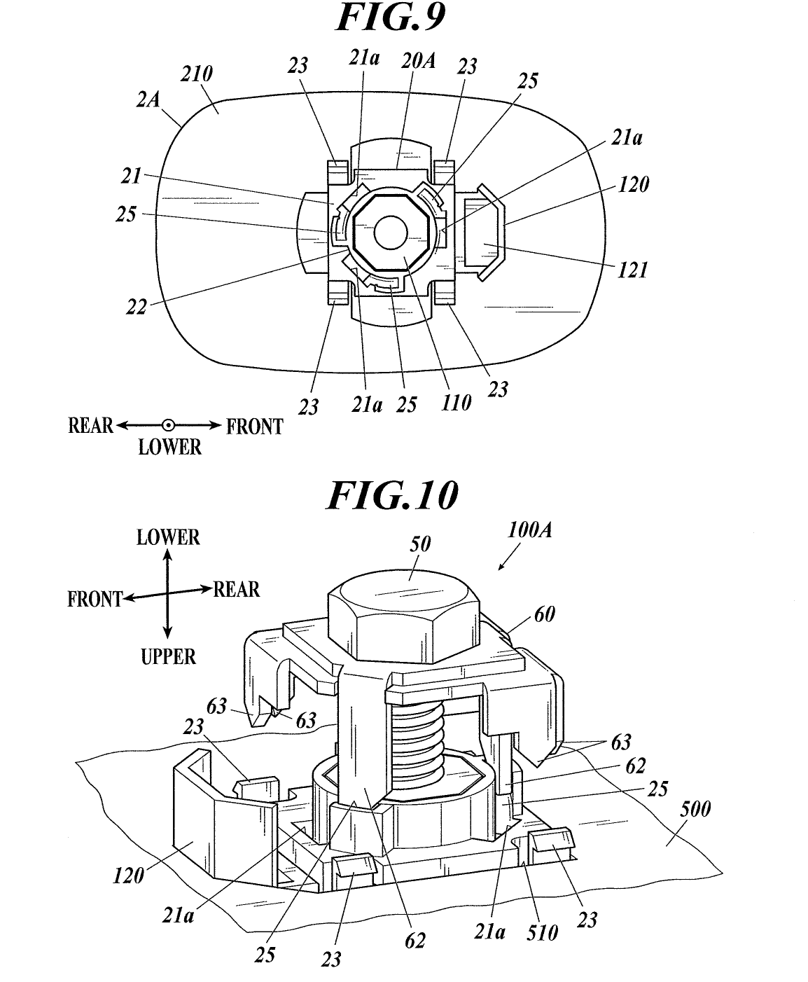

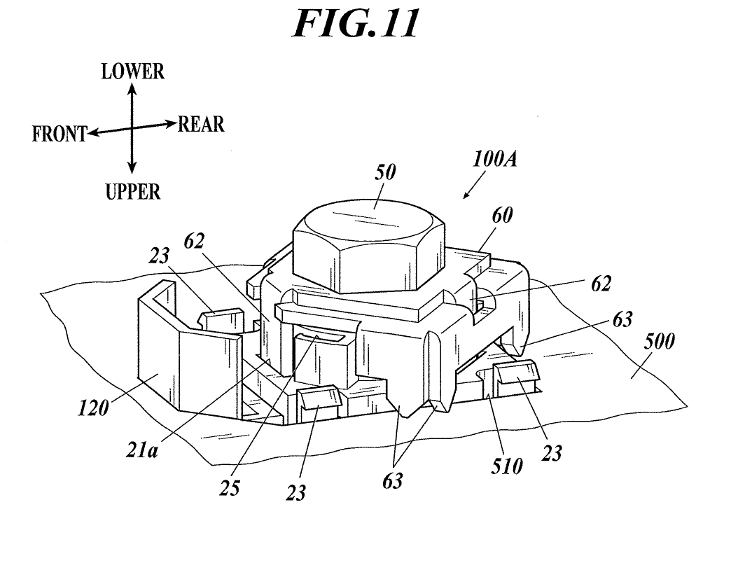

How the antenna device 1 is mounted to the mounting surface 500 of the car body by a worker will now be described in reference to FIGS. 10 and 11. FIG. 10 illustrates an antenna mounting portion 100A in the initial mounting state. FIG. 11 illustrates the antenna mounting portion 100A in the mounted state.

The antenna device 1 has been already assembled and integrated with the antenna mounting portion 100A, before the antenna device 1 is mounted to the mounting surface 500, as illustrated in FIG. 10. The worker then inserts and temporarily fixes the antenna mounting portion 100A of the antenna device 1 in the initial state into the aperture for fixing 510 on the mounting surface 500 from the upper part (from the outside of the car) to the lower part (to the inside of the car). The three legs 62 are in contact with every slope of the guides 25, respectively, in the temporarily fixed antenna mounting portion 100A in the initial state.

The worker then tightens the male screw 50, which exerts an upward axial force onto the fixing member 60. As the male screw is tightened, the tips of legs 62 are respectively guided by the guides 25 to slide on the slopes and to move toward the through holes 21a, and the fixing member 60 rotates in the clockwise direction.

The worker then completely tightens the male screw 50, which exerts an upward axial force onto the fixing member 60. With reference to FIG. 11, as the male screw 50 is tightened, the fixing member 60 further rotates in the clockwise direction until the tips of the legs 62 are inserted into the through holes 21a and fixed to the position turned by 45 degree from the position in the initial state described above. Finally, six claws 63 stick into the mounting surface 500. This causes the antenna device 1 to be fixed and grounded to the mounting surface 500.

According to the present modification, the mounting portion 100A includes the male screw 50, the female screw 111 provided on the antenna base 2 and corresponding to the male screw 50, and the fixing member 60 fixed onto the mounting surface 500 when the fixing member is pinched by the male screw 50 and the female screw 111, the male screw 50 being inserted in the fixing member 60. When the fixing member 60 axially rotates about the inserted male screw 50, the state of the fixing member 60 is converted from the first state into the second state. The fixing member 60 in the first state is insertable through the aperture for fixing 510 and the fixing member 60 in the second state is not insertable through the aperture for fixing 510.

Accordingly, when the male screw 50 is tightened in the female screw 111, it is not required to ensure the prescribed length of stroke (stroke in the rotation axis direction of the male screw) for unfolding the moving parts (legs) of the legged washer as in the conventional antenna-mounting structure. As a result, the protrusion amount of the antenna mounting portion 100A into the car from the mounting surface 500 can be reduced so that the space in the car can be prevented from being narrowed.

According to the present modification, the antenna mounting portion 100A has the guides 25 which come into contact with the legs 62 of the fixing member 60 when the male screw 50 and the female screw 111 pinch the fixing member 60, so that the fixing member 60 in the first state, in which the fixing member 60 is insertable through the aperture for fixing 510, changes into the fixing member 60 in the second state, in which the fixing member 60 is not insertable through the aperture for fixing 510. In conjunction with the tightening of the male screw 50, the fixing member 60 in the first state can be smoothly changed to the fixing member 60 in the second state. Accordingly, the antenna mounting portion 100A can be mounted to the mounting surface 500 with higher work efficiency.

According to the present modification, the fixing member 60 is composed of one component. Accordingly, the number of components constituting the antenna mounting portion 100A can be reduced and the manufacturing cost of the antenna mounting portion 100A can be suppressed.

The present invention made by the inventor has been specifically described based on the embodiments and their modifications. The present invention, however, should not be limited to the embodiments and modifications described above, and can be modified without departing from the scope and sprit of the present invention.

The embodiments and modifications above describe the configuration where the rod antenna device 1 is mounted onto the mounting surface 500, and any other configurations may be available. The antenna device having an antenna mounting component may include any other on-vehicle antennas, such as shark-fin antennas.

The disclosed embodiments and modifications are mere illustrative in every respect and should not be construed to limit the invention. The scope of the present invention is defined by the accompanying claims, not by the description above, and any modification or variation of the present invention is intended to fall within claims in the sense of equivalence.

What is claimed is:

1. An antenna mounting component to be mounted to an aperture for fixing on a mounting surface of a car body, comprising:
a male screw for fixing an antenna;
a female screw which is provided on an antenna base and corresponds to the male screw; and
a fixing member which is fixed onto the mounting surface when the fixing member is pinched by the male screw and the female screw, the male screw being inserted in the fixing member, wherein,
when the fixing member axially rotates about the inserted male screw, a state of the fixing member is converted from a first state into a second state, the first state being a state in which the fixing member is insertable through the aperture for fixing and the second state being a state in which the fixing member is not insertable through the aperture for fixing.

2. The antenna mounting component according to claim 1 further comprising a guide, wherein,
when the fixing member is pinched by the male screw and the female screw, the guide contacts at least one guided portion of the fixing member so that a state of the fixing member is converted from the first state into the second state.

3. The antenna mounting component according to claim 2, wherein
the fixing member comprises a guided member and a fixing nut, the guided member comprising the at least one guided portion and the fixing nut being separate from the guided member,
the guided member has a hole in which the male screw is inserted,
the at least one guided portion comprises a plurality of guided portions disposed at equal intervals in the circumferential direction around the hole, and
the fixing nut has at least one aperture in which the guided portions are inserted.

4. The antenna mounting component according to claim 3, wherein the fixing nut comprises at least one projection which pushes at least one of the guided portions inserted in the at least one aperture.

5. The antenna mounting component according to claim 3, wherein the fixing nut has slits radially formed around the male screw inserted in the fixing member.

6. An antenna device comprising:
an antenna mounting component according to claim 1; and
an antenna.
